(19) United States
(12) Patent Application Publication
(10) Pub. No.: US 2006/0068287 A1
(43) Pub. Date: Mar. 30, 2006

(54) Negative electrode active material for nonaqueous electrolyte secondary battery and nonaqueous electrolyte secondary battery

(75) Inventors: Tomokazu Morita, Chiba (JP); Norio Takami, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/175,294

(22) Filed: Jul. 7, 2005

(30) Foreign Application Priority Data
Sep. 24, 2004 (JP) 2004-278267

(51) Int. Cl. H01M 4/52; H01M 4/58

(52) U.S. Cl. 429/223; 429/231.95

(57) ABSTRACT

A negative electrode active material for a nonaqueous electrolyte secondary battery contains a composite material containing three phases, a fine Si phase, a silicon oxide, and a carbonaceous matrix, having coated thereon carbon, and a nonaqueous electrolyte secondary battery using the negative electrode active material.

### CROSS-REFERENCE TO RELATED APPLICATIONS

This application is based upon and claims the benefit of priority from the prior Japanese Patent application No. 2004-278267, filed Sep. 24, 2004, the entire contents of which are incorporated herein by reference.

### BACKGROUND OF THE INVENTION

1. Field of the Invention

The present invention relates to a negative electrode active material for a nonaqueous electrolyte secondary battery and a nonaqueous electrolyte secondary battery that are improved in negative electrode active material.

2. Description of the Related Art

According to progress of miniaturization techniques of electronic devices in recent years, various kinds of portable electronic devices are being spread. A battery used as a power source for the portable electronic devices is also demanded to be miniaturized, and thus a nonaqueous electrolyte secondary battery, which has a high energy density, is receiving attention.

A nonaqueous electrolyte secondary battery having metallic lithium as a negative electrode active material has a considerably high energy density, but has a short battery lifetime due to deposition of dendritic crystals, which is called as dendrite, upon charging, and also has a problem in safety, for example, the dendrite growing to reach the positive electrode to cause internal shorts. As a negative electrode that can replace metallic lithium, a carbon material, particularly graphitic carbon, capable of absorbing and desorbing lithium is being used. However, the graphitic carbon is inferior in capacity in comparison to metallic lithium and a lithium alloy and thus has a problem in poor large current characteristics. Under the circumstances, there have been attempts of using such a material that has a large absorbing capacity of lithium and a high density, for example, an amorphous chalcogen compound, such as silicon and tin, as an element forming an alloy with lithium. Among these, silicon can absorb lithium atoms at a proportion of 4.4 at most per one silicon atom to provide a large negative electrode capacity per weight, which is 10 times that of graphitic carbon. However, silicon has a large volume change on absorption and desorption of lithium in a charging and discharging cycle, which brings about a problem in cycle lifetime, for example, pulverization of the active material particles.

JP-A-2000-215887 discloses that Si particles as a negative electrode material are coated with carbon, and SiO₂ may be contained as an impurity.

However, the silicon powder used as a starting raw material in this conventional technique has a large size of 0.1 μm or more, and it is difficult to prevent the active material from suffering pulverization and breakage in an ordinary charging and discharging cycle. For example, in the example thereof, silicon powder, which is a high grade reagent produced by Wako Pure Chemical Industries, Ltd., is used as silicon powder for the starting raw material, but the material is obtained by powdering crystalline silicon and has a significantly low value of 0.1° or less as a diffraction peak of the Si (220) plane in a powder X-ray diffraction measurement of the negative electrode material. It is difficult to realize a battery having a higher capacity and a higher cycle capability with the negative electrode active material having such a capability.

Accordingly, JP-A-2004-119176 and US 2004/0115535 disclose that in an active material obtained by baking and combining silicon monoxide and a carbonaceous matrix in a minute form, microcrystalline Si is encompassed or retained by SiO₂ capable of firmly bonding to Si, which is dispersed in the carbonaceous matrix, which realizes improvement in capacity and cycle capability. However, the active material has such a problem that the material has a small discharging amount per a charging amount in the first charging and discharging cycle, i.e., the charging and discharging coulombic efficiency in the first cycle is relatively low, which prevents realization of a battery having a high capacity.

As the related art that is closest to the invention, there has been a nonaqueous electrolyte secondary battery using a negative electrode active material obtained by baking and combining silicon monoxide in a minute form and a carbonaceous matrix, which has not yet been publicly known, but the related art has such a problem that the battery has a relatively low charging and discharging coulombic efficiency in the first cycle to prevent further improvement in capacity of the battery.

### BRIEF SUMMARY OF THE INVENTION

The present invention may provide, as a first aspect, a negative electrode active material for nonaqueous electrolyte battery, the material containing composite particles having silicon and a silicon oxide dispersed in a carbonaceous matrix, and a coating layer containing a carbonaceous matrix coating on a surface of the composite particles, and the material has a half width of a diffraction peak of an Si (220) plane in a powder X-ray diffraction measurement of from 1.5 to 8.0°. The negative electrode active material can be produced, for example, by a process containing steps of coating a carbon material on a precursor obtained by mechanically combining SiOₓ (0.8≦x≦1.5) and carbon or an organic material, and baking in an inert atmosphere at a temperature of from 850 to 1,300° C.

### BRIEF DESCRIPTION OF THE DRAWING

FIG. 1 is a partial cross sectional view showing an embodiment of a nonaqueous electrolyte secondary battery according to the invention.

FIG. 2 is a view showing a frame format of one embodiment of the negative electrode active material according to the invention.

### DETAILED DESCRIPTION OF THE INVENTION

The negative electrode active material of the invention will be described in detail below.

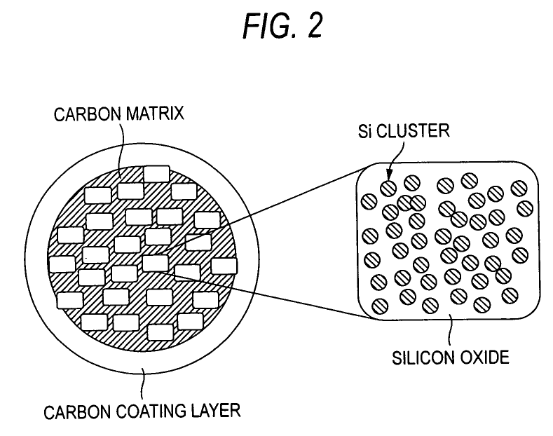

In an embodiment of the negative electrode active material of the invention, particles containing Si, SiO and SiO₂, and a carbonaceous matrix, which are preferably finely combined, are coated with carbon on the surface thereof. The frame format showing one embodiment of the negative electrode active material according to the invention is shown in FIG. 2. The Si phase absorbs and desorbs a large amount of lithium to improve largely the capacity of the negative electrode active material. The expansion and contraction occurring upon absorption and desorption of lithium in the Si phase is relaxed by distributing to the other two phases than the Si phase, whereby the active material particles are prevented from being pulverized. Simultaneously, the carbonaceous matrix phase ensures electroconductivity, which is important as a negative electrode material, and the SiO2 phase is firmly bonded to the Si phase to exert a significant effect of maintaining the particle structure by functioning as a buffer for retaining the Si phase having been finely dispersed. The carbon coating the surface of the particles has such an effect that suppresses the surface side reaction in the first charging and discharging cycle from occurring to improve the charging and discharging coulombic efficiency in the first cycle. It is considered that the reason why the charging and discharging coulombic efficiency in the first charging cycle is lowered in a mechanical composite of silicon monoxide and a carbonaceous matrix is that, as a result of the mechanical combining process of silicon monoxide and a carbonaceous matrix, the specific surface area is increased, and distortions and defects are formed on the surface thereof, so as to store a large surface energy, which facilitates the surface side reaction. It is expected that the specific surface area can be decreased by coating the surface with carbon to reduce the surface energy, whereby the surface side reaction in the first charging cycle is suppressed from occurring to improve the charging and discharging coulombic efficiency. Therefore, it is preferred that the surface of the particles is uniformly and sufficiently coated, and the coated amount is preferably 2% by weight or more, and more preferably 40% by weight or more.

However, since, for an excessively large amount of carbon coating, the relative amount of Si reduces to make the absorbed lithium amount in the overall amount of the active material decrease, the amount of carbon coating should particularly preferably lie in the range of from 2 to 15% by weight. The carbon coating amount can be calculated by measuring the weight ratios or compositional ratios before and after the carbon coating treatment.

In addition, the amount of carbon coating in a carbon-coated sample can be measured by the following method. First of all, the superficial composition of a powder-form sample is measured by means of XPS. In the measurement in which, along with the removal of the sample surface by Ar etching, the compositional change in the thickness direction is measured, the depth at which the carbon content drastically decreases is considered to represent the thickness of the carbon coating layer. Based on this fact, the average thickness of the superficial carbon coating layer can be determined.

Secondly, the quantity of carbon coating is calculated by measuring the specific surface area of the sample, and assuming that a carbon layer of the average thickness is formed for that area.

It is further desirable to directly observe the thickness of the superficial coverage layer by means of TEM to confirm the validity of the layer thickness derivation based on the aforementioned method.

The Si-phase exhibits large expansion and contraction when it absorbs and releases lithium. In order to relax the stresses for such changes, it is preferred that the Si-phase is dispersed in carbonaceous particles in the form dispersed as finely as possible. Specifically, the Si-phase is preferably dispersed in the range of from several nm size clusters to 300 nm at largest. More preferably, the average size of the Si-phase should not exceed 100 nm. The reason is that, with the increase of the Si-phase size, the localized volume changes due to the expansion and contraction of the Si-phase increases, and that, thus, when the size of the Si-phase on average increases to 100 nm or more, the active material for the negative electrode gradually collapses with the repetition of the charging and discharging cycles to shorten the cycle lifetime of the secondary cell.

Further, the lower limit for the average Si-phase size is preferably 1 nm from the following reason. When the average size of the Si-phase is less than 1 nm, the ratio of the Si atoms located at the surface of the crystal in those constituting the Si-phase increases. Since the Si atoms located at the outermost surface of the Si-phase, which form bonds with foreign atoms such as oxygen, do not contribute to lithium absorption, the absorption amount of lithium noticeably decreases when the Si-phase size becomes less than 1 nm.

A more preferable range for the average Si-phase size is 2 nm to 50 nm.

The size of Si-phase can be observed by means of a transmission electron microscope (TEM). The sample for TEM observation is prepared by suspending a small amount of the powder in liquid ethanol and dropping the suspension on a collodion film. After the collodion film, on which the suspension has been dropped, is thoroughly dried, observation with a TEM at a magnification of about 500,000 to 2,000,000 is conducted. In the observation, the Si-phase appears as black spots against a silicon oxide phase in a bright-field image. In the dark-field image of the Si (111) diffraction lines, the silicon micro-crystals are clearly observed as white spots. By measuring the dimension of these silicon micro-crystals, the size of the Si-phase can be determined.

The SiO₂ phase may be an amorphous phase or a crystalline phase and is preferably dispersed in the active material particles uniformly in such a manner that the SiO₂ phase is bonded to the Si phase to encompass or retain the Si phase.

The carbonaceous matrix that is combined with the Si phase inside the particles is preferably graphite, hard carbon, soft carbon, amorphous carbon or acetylene black, which may be used solely or in combination of plural kinds thereof, and the carbonaceous matrix containing only graphite or a combination of graphite and hard carbon are more preferred. Graphite is preferred since it improves the electroconductivity of the active material, and has a large effect on relaxing the stress due to the expansion and contraction by coating the entire hard carbon active material. The carbonaceous matrix preferably has such a shape that encompasses the Si phase and the SiO₂ phase.

The carbonaceous matrix that is coated on the surface is preferably hard carbon or soft carbon. Discrimination of hard carbon from soft carbon results from the difference in the ease of graphite structure development depending on the difference in the reaction procedure when carbonization or graphitization is carried out by heat treatment.

In the case where carbonization is carried out by heat-treating a material in gas or liquid phase, or one which melts upon heating as a raw material, soft carbon is obtained in which rearrangement to graphite structure is easy to proceed. On the other hand, in the case of using a raw material such as a thermo-setting resin with which carbonization or graphite formation reaction proceeds in solid phase throughout the reaction, hard carbon is obtained in which graphite structure is difficult to develop, since the rearrangement of the original structure (the network of carbon-carbon linkage) is difficult to proceed. Specifically, the raw material for soft carbon includes gases such as ethylene and methane, organic solvents, pitches, etc. The raw material for hard carbon includes thermo-setting resins such as epoxy resin, urethane resin, phenol resin, etc., and the pitches that have been converted to a non-melting form via partial oxidation treatment.

Since carbon atoms are randomly arranged in hard carbon compared to those in soft carbon, many defects, voids and the like are included whereby it is anticipated that the stress caused by the volume change in the Si-phase may be mitigated more easily.

In the XRD pattern of soft carbon, the peak of graphite structure is higher and sharper in soft carbon than that of hard carbon due to the difference in the structure.

Moreover, by TEM observation, it can be confirmed that in hard carbon calcined at about 1000° C. minute carbonaceous crystallites exist isotropical and random. In soft carbon, comparatively well aligned graphite crystals can be observed. Hard carbon is particularly preferred since it suffers substantially no volume change upon absorption and desorption of lithium to exert large resistance to stress.

The negative electrode active material preferably has a particle diameter of from 5 to 100 μm and the carbon coating layer of the particle preferably has a specific surface area of from 0.5 to 10 m²/g. The particle diameter of the active material and the specific surface area of the carbon coating layer influence the rate of the absorption and desorption reaction of lithium to affect the negative electrode characteristics largely, and those within the aforementioned ranges provide the favorable characteristics stably.

It is necessary that the active material has a half width of a diffraction peak of an Si (220) plane in a powder X-ray diffraction measurement of from 1.5 to 8.0°. The half width of the diffraction peak of the Si (220) plane is reduced associated with the growth of the crystalline particles of the Si phase, and when the crystalline particles of the Si phase are largely grown, breakage of the active material particles is facilitated by expansion and contraction upon absorption and desorption of lithium. The problem can be avoided in the case where the half width is in the range of from 1.5 to 8.0°.

The proportion of the Si phase, the SiO₂ phase and the carbonaceous matrix phase is preferably that the molar ratio of Si and carbon satisfies 0.2≦Si/carbon≦2. The proportion of the Si phase and the SiO₂ phase preferably satisfies 0.6≦Si/SiO₂≦1.5 since the negative electrode active material can have a large capacity and a good cycle capability.

The process for producing the negative electrode active material for a nonaqueous electrolyte secondary battery according to the embodiment will be described.

Examples of the mechanical combining treatment include a turbo mill, a ball mill, a mechanofusion and a disk mill.

The Si raw material is preferably SiOₓ (0.8≦x≦1.5), and SiO (x≈1) is more preferably used for obtaining a preferred proportion of the Si phase and the SiO₂ phase. The state of SiOₓ is preferably powder for reducing the treating time, and it more preferably has a particle diameter of from 0.5 to 100 μm, while it may be in an aggregated state. This is because of the following reasons. In the case where the average particle diameter exceeds 100 μm, the Si phase is thickly covered with the insulating SiO₂ phase in the center part of the particles, whereby there is such a possibility that the lithium absorption and desorption reaction of the active material is impaired. In the case where the average particle diameter is less than 0.5 μm, on the other hand, the surface area is increased to cause such a possibility that SiO₂ is exposed on the particle surface to make the composition unstable.

The organic material may be at least one of a carbon material, such as graphite, coke, low-temperature fired charcoal and pitch, and a carbon material precursor. A material that is melted upon heating, such as coke, impairs the favorable combining treatment by melting upon treating in a mill, and therefore, those that are not melted, such as coke and graphite, are preferably used.

The operation conditions for the combining treatment vary depending on the device used, and the treatment is preferably carried out until the pulverization and combining are sufficiently effected. However, in the case where the output power of the device is too large upon combining, or the period of time for combining is too long, Si and C are reacted with each other to form SiC, which is inert to the absorption reaction of lithium. Therefore, it is necessary that the operation conditions are appropriately determined in such a manner that the pulverization and combining are sufficiently effected, but no SiC is formed.

Subsequently, carbon is coated on the particles obtained through the combining step. The material to be coated may be a material that becomes a carbonaceous matrix upon heating in an inert atmosphere, such as pitch, a resin and a polymer. Specifically, it is preferred to use a material that is well carbonized at a temperature of about 1,200° C., such as petroleum pitch, mesophase pitch, a furan resin, cellulose and a rubber material. This is because the baking step cannot be effected at a temperature exceeding 1,400° C. as described later for the baking treatment. Upon coating, the composite particles are dispersed in a monomer, and after polymerizing the monomer, the particles are subjected to baking for carbonization. In alternative, a polymer is dissolved in a solvent, in which the composite particles are dispersed, and after obtaining a solid product by evaporating the solvent, the solid product is subjected to baking for carbonization. Furthermore, it is possible to effect carbon coating with CVD. In this process, a gaseous carbon source is fed along with an inert gas as a carrier gas on the particles heated to a temperature of from 800 to 1,000° C., whereby the carbon source is carbonized on the surface of the particles. In this case, the carbon source may be benzene, toluene, styrene and the like. In the case where the carbon coating is effected by CVD, the baking step described later may not be carried out since the particles are heated to a temperature of from 800 to 1,000° C.

The baking step is carried out in an inert atmosphere, such as argon. Upon baking for carbonization, the polymer or pitch is carbonized, and simultaneously, SiOₓ is separated into two phases, Si and SiO₂, through a disproportionation reaction. The reaction where x=1 can be expressed by the following formula (1).
2SiO→Si+SiO₂ (1)

The disproportionation reaction proceeds at a temperature of 800° C. or higher, and SiOₓ is finely separated into the Si phase and the SiO₂ phase. The size of crystals of the Si phase is increased upon increasing the reaction temperature to reduce the half width of the peak of the Si (220) plane. The baking temperature that provides a half width in the preferred range is from 850 to 1,600° C. The Si phase formed through the disproportionation reaction is reacted with carbon at a temperature higher than 1,300° C. to form SiC. SiC is completely inert to the absorption of lithium, and the formation of SiC deteriorates the capacity of the active material. Therefore, the temperature upon baking for carbonization is preferably from 850 to 1,300° C., and more preferably from 900 to 1,100° C. The baking time is preferably about from 1 to 12 hours.

The negative electrode active material of the invention can be obtained through the aforementioned production process. The product after the baking for carbonization may be adjusted in particle diameter, specific surface area and the like by using various kinds of mill, a pulverizing device and a grinder.

The production of a nonaqueous electrolyte secondary battery using the negative electrode active material of the invention will be described.

(1) Positive Electrode

The positive electrode has such a structure that a positive electrode active material layer containing an active material is supported on one surface of both surfaces of a positive electrode collector.

The positive electrode active material layer preferably has a thickness of from 1.0 to 150 μm from the standpoint of retaining the large current characteristics and the cycle lifetime of the battery. Therefore, in the case where the active material layers are supported on both surfaces of a positive electrode collector, the total thickness of the positive electrode active material layers is preferably from 20 to 300 μm. The thickness of the active material layer per one surface is more preferably from 30 to 120 μm. The large current characteristics and the cycle lifetime of the battery can be improved within the range.

The positive electrode active material layer may contain an electroconductive agent in addition to the positive electrode active material.

The positive electrode active material layer may further contain a binder for binding the materials for the positive electrode.

Preferred examples of the positive electrode active material that provide a high voltage include various kinds of oxides, such as manganese dioxide, a complex oxide of lithium and manganese, lithium-containing cobalt oxide (e.g., LiCoO₂), lithium-containing nickel cobalt oxide (e.g., LiNi_{0.8}Co_{0.2}O₂), a complex oxide of lithium and manganese (e.g., LiMn₂O₄ and LiMnO₂), ternary positive electrode materials containing Mn, Ni and Co (e.g., LiMn_{1/3}Ni_{1/3}Co_{1/3}O₂), and lithium iron phosphate (e.g., LiFePO₄).

Examples of the electroconductive agent include acetylene black, carbon black and graphite.

Examples of the binder include polytetrafluoroethylene (PTFE), polyvinylidene fluoride (PVdF), an ethylene-propylene-diene copolymer (EPDM) and styrene-butadiene rubber (SBR).

The mixing ratio of the positive electrode active material, the electroconductive agent and the binder is from 80 to 95% by weight for the positive electrode active material, from 3 to 20% by weight for the electroconductive agent, and from 2 to 7% by weight for the binder, for obtaining good large current discharging characteristics and a good cycle lifetime.

The collector may be an electroconductive substrate having a porous structure or a non-porous electroconductive substrate. The collector preferably has a thickness of from 5 to 20 μm. This is because the electrode strength and the weight saving can be well attained in a balanced manner within the range.

(2) Negative Electrode

The negative electrode has such a structure that a negative electrode active material layer containing an active material is supported on one surface of both surfaces of a negative electrode collector.

The negative electrode active material layer preferably has a thickness of from 1.0 to 150 μm. Therefore, in the case where the active material layers are supported on both surfaces of a negative electrode collector, the total thickness of the negative electrode active material layers is preferably from 20 to 300 μm. The thickness of the active material layer per one surface is more preferably from 30 to 100 μm. The large current characteristics and the cycle lifetime of the battery can be improved within the range.

The negative electrode active material layer may contain a binder for binding the materials for the negative electrode. Examples of the binder include polytetrafluoroethylene (PTFE), polyvinylidene fluoride (PVdF), an ethylene-propylene-diene copolymer (EPDM) and styrene-butadiene rubber (SBR).

The negative electrode active material layer may contain an electroconductive agent. Examples of the electroconductive agent include acetylene black, carbon black and graphite.

The collector may be an electroconductive substrate having a porous structure or a non-porous electroconductive substrate. The collector may be formed, for example, of copper, stainless steel or nickel. The collector preferably has a thickness of from 5 to 20 μm. This is because the electrode strength and the weight saving can be well attained in a balanced manner within the range.

(3) Electrolyte

The electrolyte may be a nonaqueous electrolytic solution, an electrolyte-impregnated polymer electrolyte, a polymer electrolyte or an inorganic solid electrolyte.

The nonaqueous electrolytic solution is a liquid electrolyte prepared by dissolving an electrolyte in a nonaqueous solvent and retained in gaps among the electrodes.

Preferred examples of the nonaqueous solvent include a nonaqueous solvent mainly containing a mixed solvent of propylene carbonate (PC) or ethylene carbonate (EC) with a solvent having a viscosity lower than PC or EC (hereinafter, referred to as a second solvent).

Preferred examples of the second solvent include a linear carbon, and among these, more preferred examples thereof include dimethyl carbonate (DMC), methylethyl carbonate (MEC), diethyl carbonate (DEC), ethyl propionate, methyl propionate, γ-butyrolactone (BL), acetonitrile (AN), ethyl acetate (EA), toluene, xylene and methyl acetate (MA). The second solvent may be used solely or in combination of two or more kinds thereof. In particular, the second solvent preferably has a donner number of 16.5 or less.

The second solvent preferably has a viscosity of 2.8 cmp or less at 25° C. The mixing amount of ethylene carbonate or propylene carbonate in the mixed solvent is preferably from 1.0 to 80% by volume. The more preferred mixing amount of ethylene carbonate or propylene carbonate is from 20 to 75% by volume.

Examples of the electrolyte contained in the nonaqueous electrolytic solution include lithium salts (electrolytes), such as lithium perchlorate (LiClO₄), lithium phosphate hexafluoride (LiPF₆), lithium borofluoride (LiBF₄), lithium arsenic hexafluoride (LiAsF₆), lithium trifluorometaslufonate (LiCF₃SO₃) and bistrifluoromethylsulfonylimide lithium (LiN(CF₃SO₂)₂). Among these, LiPF₆ and LiBF₄ are preferably used.

The dissolved amount of the electrolyte in the nonaqueous solvent is preferably from 0.5 to 2.0 mol/L.

(4) Separator

A separator may be used in the case where a nonaqueous electrolytic solution is used, and in the case where an electrolyte-impregnated polymer electrolyte is used. A porous separator may be used as the separator. Examples of the material for the separator include a porous film containing polyethylene, polypropylene or polyvinylidene fluoride (PVdF), and a synthetic resin nonwoven cloth. Among these, a porous film formed of polyethylene, polypropylene or both of them, is preferably used since the secondary battery can be improved in safety.

The separator preferably has a thickness of 30 μm or less. In the case where the thickness exceeds 30 μm, there is such a possibility that the internal resistance is increased due to the increased distance between the positive electrode and the negative electrode. The lower limit of the thickness is preferably 5 μm or less. In the case where the thickness is less than 5 μm, the strength of the separator is considerably lowered to cause a possibility of internal shorts. The upper limit of the thickness is more preferably 25 μm, and the lower limit thereof is more preferably 1.0 μm.

The separator preferably has a thermal contraction degree of 20% or less upon allowing to stand at 120° C. for 1 hour. In the case where the thermal contraction degree exceeds 20%, there is an increased possibility of causing shorts under heat. The thermal contraction degree is more preferably 15% or less.

The separator preferably has a porosity of from 30 to 70%. This is because of the following reasons. In the case where the porosity is less than 30%, there is such a possibility that the separator cannot have high electrolyte holding capability. In the case where the porosity exceeds 70%, there is such a possibility that the separator cannot have a sufficient strength. The porosity is more preferably from 35 to 70%.

The separator preferably has an air permeability of 500 seconds or less per 1.00 cm³. In the case where the air permeability exceeds 500 seconds per 1.00 cm³, there is such a possibility that the separator cannot have a high lithium ion mobility. The lower limit of the air permeability is preferably 30 seconds per 1.00 cm³. In the case where the air permeability is less than 30 seconds per 1.00 cm³, there is such a possibility that the separator cannot have a sufficient strength.

The upper limit of the air permeability is more preferably 500 seconds per 1.00 cm³, and the lower limit thereof is more preferably 50 seconds per 1.00 cm³.

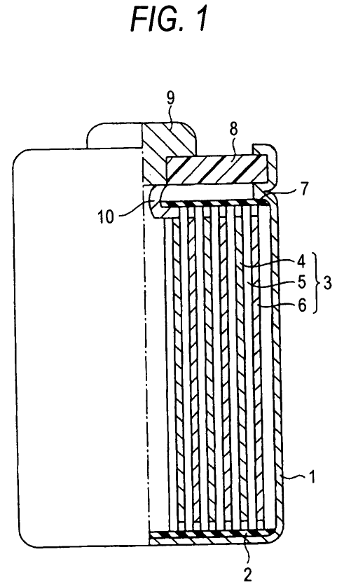

A cylindrical nonaqueous electrolyte secondary battery as an example of the nonaqueous electrolyte secondary battery of the invention will be described in detail below with reference to FIG. 1.

A container 1 in the form of a cylinder having a bottom formed of stainless steel has an insulating body 2 disposed on the bottom thereof. A group of electrodes 3 is housed in the container 1. The group of electrodes 3 has such a structure that a strip obtained by accumulating a positive electrode 4, a separator 5, a negative electrode 6 and a separator 5 is wound in a spiral form to make the separator 5 be disposed outward.

An electrolytic solution is housed in the container 1. Insulating paper 7 having an opening at the center thereof is disposed above the group of electrodes 3 in the container 1. A insulating sealing plate 8 is disposed on an upper opening of the container 1 and fixed to the container 1 by crimping the container 1 in the vicinity of the upper opening thereof. A positive electrode terminal 9 is fixed to the center of the insulating sealing plate 8. One end of a positive electrode lead wire 10 is connected to the positive electrode 4, and the other end thereof is connected to the positive electrode terminal 9. The negative electrode 6 is connected to the container 1 as a negative electrode terminal through a negative electrode lead wire, which is not shown in the figure.

An example where the invention is applied to a cylindrical nonaqueous electrolyte secondary battery is shown in FIG. 1, but the invention can also be applied to a square nonaqueous electrolyte secondary battery. The group of electrodes housed in the container of the battery is not limited to the spiral form but may be such a structure that positive electrodes, separators and negative electrodes may be plurally accumulated in this order.

An example where the invention is applied to a nonaqueous electrolyte secondary battery having an outer housing formed of a metallic canister, but the invention can also be applied to a nonaqueous electrolyte secondary battery having an outer housing formed of a film material. The film material is preferably a laminated film of a thermoplastic resin and an aluminum layer.

One of the features of the negative electrode active material for a nonaqueous electrolyte secondary battery of the embodiment described in the foregoing according to the invention is that the material is a compound containing three phases, Si, SiO₂ and a carbonaceous matrix.

The negative electrode active material can attain a high charging and discharging capacity and a prolonged cycle lifetime simultaneously, and therefore, a nonaqueous electrolyte secondary battery having an improved discharging capacity and a prolonged service life can be realized.

### EXAMPLES

The invention will be described for the effects thereof with reference to the following specific examples thereof (i.e., specific examples of the battery described with reference to FIG. 1 produced under the conditions noted in the examples, respectively), but the invention is not construed as being limited thereto.

### Example 1

A negative electrode active material was synthesized by the raw material composition, the ball mill driving conditions, and the baking conditions, shown below. The ball mill used was a planetary ball mill (Model P-5, produced by Fritsch GmbH).

Upon dispersing in the ball mill, a stainless steel vessel having a capacity of 250 mL and balls having a diameter of 10 mm were used, and the amount of the raw materials to be dispersed was 20 g. 8 g of SiO powder having an average particle diameter of 45 μm and, as a carbonaceous matrix, 12 g of graphite powder having an average particle diameter of 6 μm were used as raw materials. The rotation number of the ball mill was 150 rpm, and the processing time was 18 hours.

Composite particles obtained by the treatment with the ball mill were coated with carbon in the following manner. 3 g of the composite particles were mixed with a mixed solution of 3.0 g of furfuryl alcohol, 3.5 g of ethanol and 0.125 g of water, followed by kneading. 0.2 g of diluted hydrochloric acid as a polymerization initiator for furfuryl alcohol was added thereto, and the mixture was allowed to stand at room temperature to obtain coated composite particles as composite particles before baking, in which fine particles of silicon oxide having a diameter of from 0.3 to 2 μm were dispersed in the carbonaceous matrix, and superfine particles of silicon having a diameter of from 5 to 15 nm were dispersed in the fine particles.

The resulting carbon-coated composite material was baked in an argon gas at 1,000° C. for 3 hours, and after cooling to room temperature, the material was pulverized and sieved through a 30 μm mesh to obtain a negative electrode active material, in which the baked composite particles had hard carbon (i.e., carbon that was not graphitized upon baking at a temperature of from 2,800 to 3,000° C.) as a coated layer on the surface thereof.

The active material obtained in Example 1 was subjected to the charging and discharging test, the charging and discharging test in a cylindrical battery (FIG. 1), the X-ray diffraction measurement and the BET measurement in the following manner to evaluate the charging and discharging characteristics and the physical properties.

(Charging and Discharging Test)

The resulting active material as a specimen was kneaded with 30% by weight of graphite having an average particle diameter of 6 μm and 12% by weight of polyvinylidene fluoride along with N-methylpyrrolidone as a dispersing medium, and the kneaded product was coated on a copper foil and rolled to a thickness of 12 μm. The coated and rolled product was dried in vacuum at 100° C. for 12 hours to obtain a test electrode. A battery was produced in an argon atmosphere by using a counter electrode and a reference electrode, which were formed with metallic lithium, respectively, and a 1M EC/DEC (volume ratio: 1/2) solution of LiPF₆ as an electrolytic solution, and the charging and discharging test was carried out. In the conditions for the charging and discharging test, charging was carried out at an electric current density of 1 mA/cm² until the potential difference between the reference electrode and the test electrode reached 0.01 V, charging was continued at a constant voltage of 0.01 V for 8 hours, and discharging was carried out at an electric current density of 1 mA/cm² until 1.5 V.

(Charging and Discharging Test in Cylindrical Battery)

The negative electrode active material was coated and rolled on a collector in the same manner as in the charging and discharging test to obtain a test electrode for a negative electrode. A positive electrode was produced by using LiNiO₂ as an active material, acetylene black as an electroconductive agent, and polyvinylidene fluoride as a binder, a mixture of which was coated on both surfaces of an aluminum foil collector having a thickness of 20 μm. A 1M EC/DEC (volume ratio: 1/2) solution of LiPF₆ was used as an electrolytic solution. An electrode was produced by winding the positive electrode, a polypropylene separator and the negative electrode, followed by drying in vacuum at 100° C. for 12 hours. The electrode was sealed in a stainless steel canister having a diameter of 18 mm and a height of 650 mm for a cylindrical battery along with the electrolytic solution in an argon atmosphere, so as to obtain a cylindrical battery. The conditions for the charging and discharging test were as follows. In the initial charging and discharging cycle, charging was carried out at an electric current of 200 mA until 4.2 V, charging was continued at a constant voltage of 4.2 V for 3 hours, and after completing the charging, the battery was allowed to stand for 12 hours. Discharging was carried out at an electric current of 500 mA until 2.7 V. In the second cycle and later, charging was carried out at an electric current of 1 A until 4.2 V, charging was continued at a constant voltage of 4.2 V for 3 hours, and discharging was carried out at an electric current of 1 A until 2.7 V. Five cycles of charging and discharging were carried out under the aforementioned conditions, and the discharging capacity of the fifth cycle was measured as a call capacity.

(X-Ray Diffraction Measurement)

The resulting powder specimen was subjected to powder X-ray diffraction measurement to measure a half width value of the peak of the Si (220) plane. The measurement was carried out by using an X-ray diffraction measuring apparatus (Model M18XHF22, produced by MAC Science Co., Ltd. under the following conditions.
Counter cathode: Cu
Tube voltage: 50 kV
Tube current: 300 mA
Scanning rate: 1° (2θ/min)
Receiving slit: 0.15 mm
Divergence slit: 0.5°
Scattering slit: 0.5°

A half width (°(2θ)) of the plane index (220) of Si appearing at d=1.92 Å (2θ=47.2°) was measured from the resulting diffraction pattern. In the case where the peak of Si (220) overlapped a peak of the other materials contained in the active material, the target peak was isolated for measurement of the half width.

(Measurement of Specific Surface Area)

The measurement of the specific surface area was carried out by the BET measurement using an N₂ gas.

The discharging capacity, the initial charging and discharging coulombic efficiency and the discharge-capacity retention after 50 cycles in the charging and discharging test, the half width of the peak of Si (220) obtained by the powder X-ray diffraction, and the measurement results of specific surface area by the BET measurement are shown in Table 1.

TABLE 1

| | | | Characteristics of negative electrode | | | |
|---|---|---|---|---|---|---|
| | | | | Initial | | |
| | Properties of active material | | | discharging | Discharge-capacity | |
| | Half width of | | Discharging | and charging | retention | Capacity of |
| | Si(220) peak in | BET surface | capacity | coulombic | after 50 cycles | 18650 type |
| | XRD | area (m²/g) | (mAh/g) | efficiency (%) | (%) | battery (mAh) |
| Example 1 | 4.41 | 4.23 | 866 | 85 | 96.5 | 3,320 |
| Example 2 | 4.28 | 4.87 | 832 | 83 | 96.2 | 3,183 |
| Example 3 | 4.34 | 5.67 | 843 | 80 | 95.2 | 3,140 |
| Example 4 | 4.01 | 8.77 | 897 | 78 | 96.2 | 3,180 |
| Example 5 | 1.50 | 0.50 | 688 | 82 | 97.1 | 2,980 |
| Example 6 | 8.00 | 10.0 | 810 | 73 | 93.4 | 2,920 |
| Comparative | 4.22 | 14.6 | 910 | 52 | 92.2 | 2,340 |
| Example 1 | | | | | | |
| Comparative | 0.3 | 3.52 | 866 | 88 | 24.1 | 2,704 |
| Example 2 | | | | | | |
| Comparative | 11.0 | 10.9 | 442 | 48 | 38.2 | 1,816 |
| Example 3 | | | | | | |
| Comparative | 0.3 | 0.4 | 321 | 41 | 33.2 | 1,307 |
| Example 4 | | | | | | |

The results of Examples and Comparative Examples shown below are also shown in Table 1. In Examples and Comparative Examples below, the parts that are different from Example 1 are described, and descriptions for the other procedures for synthesis and evaluation were omitted since they are the same as in Example 1.

### Example 2

The silicon monoxide-carbon composite particles produced by combining in the same manner as in Example 1 were used, and the carbon coating was formed in the following manner.

The carbon coating was formed by using polystyrene. 2.25 g of polystyrene particles having a size of 5 mm were dissolved in 5 g of toluene to form a solution, to which 3 g of the composite particles were added and kneaded. The resulting mixture in a slurry form was allowed to stand at room temperature to evaporate toluene, whereby coated composite particles were obtained. The resulting particles were baked under the same conditions as in Example 1 to obtain a negative electrode active material.

### Example 3

The silicon monoxide-carbon composite particles produced by combining in the same manner as in Example 1 were used, and the carbon coating was formed in the following manner.

The carbon coating was formed by using cellulose. 1 g of carboxymethyl cellulose was dissolved in 30 g of water to form a solution, to which 3 g of the composite particles were dispersed and kneaded. The resulting slurry was allowed to stand at room temperature to evaporate water, whereby coated composite particles were obtained. The resulting particles were baked under the same conditions as in Example 1 to obtain a negative electrode active material.

### Example 4

The silicon monoxide-carbon composite particles produced by combining in the same manner as in Example 1 were used, and the carbon coating was formed in the following manner.

The carbon coating was formed by CVD. 3 g of the active material was placed in a horizontal tubular electric furnace having an argon atmosphere, and after increasing the temperature to 950° C., an argon gas containing benzene vapor was introduced therein at a flow rate of 120 mL/min. The CVD process was carried out for 3 hours to obtain carbon-coated composite particles. The active material thus obtained was not subjected to a baking treatment.

### Example 5

A carbon-coated composite material obtained by carrying out combining and coating in the same manner as in Example 1 was baked in an argon gas at 1,300° C. for 1 hour, and after cooling to room temperature, the material was pulverized and sieved through a 30 μm mesh to obtain a negative electrode active material.

### Example 6

A carbon-coated composite material obtained by carrying out combining and coating in the same manner as in Example 1 was baked in an argon gas at 850° C. for 4 hours, and after cooling to room temperature, the material was pulverized and sieved through a 30 μm mesh to obtain a negative electrode active material.

### Comparative Example 1

The silicon monoxide-carbon composite particles produced by combining in the same manner as in Example 1 were used, and no carbon coating was formed but subjected to the baking treatment to obtain an active material.

### Comparative Example 2

The silicon monoxide used as the raw material for the ball mill treatment in Example 1 was changed to 5 g of silicon powder having a particle diameter of 5 μm and 12 g of graphite powder having an average particle diameter of 6 μm. The subsequent process was carried out in the same manner as in Example 2 to effect carbon coating using furfuryl alcohol and baking, whereby an active material was obtained.

### Comparative Example 3

A carbon-coated composite material obtained by carrying out combining and coating in the same manner as in Example 1 was baked in an argon gas at 780° C. for 6 hours, and after cooling to room temperature, the material was pulverized and sieved through a 30 μm mesh to obtain a negative electrode active material.

### Comparative Example 4

As similar to Comparative Example 2, 5 g of silicon powder having a particle diameter of 5 μm and 12 g of graphite powder having an average particle diameter of 6 μm were combined. 5 g of petroleum pitch having been pulverized was further combined with a planetary ball mill. The resulting carbon-coated composite particles were baked in an argon gas at 2,000° C. for 1 hour, and after cooling to room temperature, the particles were pulverized and sieved through a 30 μm mesh to obtain a negative electrode active material.

What is claimed is:

1. A negative electrode active material for nonaqueous electrolyte battery, comprising:
composite particles containing a silicon and a silicon oxide dispersed in a carbonaceous matrix; and
a coating layer comprising a carbonaceous matrix coating on a surface of the composite particles, wherein the material has a half width of a diffraction peak of an Si (220) plane in a powder X-ray diffraction measurement of from 1.5 to 8.0°.

2. The negative electrode active material according to claim 1, wherein the carbonaceous matrix of the coating layer coats an overall surface of the composite particles.

3. The negative electrode active material according to claim 1, wherein the coating layer has a specific surface area of from 0.5 to 10 m²/g.

4. The negative electrode active material according to claim 1, wherein the material comprises the coating layer in an amount of from 2 to 40% by weigh.

5. The negative electrode active material according to claim 1, wherein the silicon has a size of 2 to 50 nm.

6. The negative electrode active material according to claim 1, wherein the carbonaceous matrix of the coating layer is a hard carbon.

7. The negative electrode active material according to claim 6, wherein the hard carbon is produced from one of epoxy resin, urethane resin, phenol resin, and pitches.

8. A secondary battery comprising the negative electrode active material according to claim 1.

9. A nonaqueous electrolyte battery comprising:
a positive electrode;
a negative electrode comprising a negative electrode active material opposite to the positive electrode, the material comprising: composite particles containing a silicon and a silicon oxide dispersed in a carbonaceous matrix; and a coating layer comprising a carbonaceous matrix coating on a surface of the composite particles, wherein the material has a half width of a diffraction peak of an Si (220) plane in a powder X-ray diffraction measurement of from 1.5 to 8.0°; and
a nonaqueous electrolyte between the negative electrode and the positive electrode.

10. The nonaqueous electrolyte battery according to claim 9, wherein the carbonaceous matrix of the coating layer coats an overall surface of the composite particles.

11. The nonaqueous electrolyte battery according to claim 9, wherein the coating layer has a specific surface area of from 0.5 to 10 m²/g.

12. The nonaqueous electrolyte battery according to claim 9, wherein the material comprises the coating layer in an amount of from 2 to 40% by weigh.

13. The nonaqueous electrolyte battery according to claim 9, wherein the material comprises the coating layer in an amount of from 2 to 15% by weigh.

14. The nonaqueous electrolyte battery according to claim 9, wherein the silicon has a size of 1 to 300nm.

15. The nonaqueous electrolyte battery according to claim 9, wherein the silicon has a size of 2 to 50nm.

16. The nonaqueous electrolyte battery according to claim 9, wherein the carbonaceous matrix of the coating layer is a hard carbon.

17. The nonaqueous electrolyte battery according to claim 16, wherein the hard carbon is produced from one of epoxy resin, urethane resin, phenol resin, and pitches.

18. The nonaqueous electrolyte battery according to claim 9, which comprises a separator between the negative electrode and the positive electrode.

19. The nonaqueous electrolyte battery according to claim 9, wherein the positive electrode is selected from manganese dioxide, a complex oxide of lithium and manganese, lithium-containing cobalt oxide, lithium-containing nickel cobalt oxide, a complex oxide of lithium and manganese, a ternary positive electrode material containing Mn, Ni and Co, and lithium iron phosphate.

20. A secondary battery comprising the nonaqueous electrolyte battery according to claim 9.
